(19) United States
(12) Patent Application Publication
(10) Pub. No.: US 2025/0287323 A1
(43) Pub. Date: Sep. 11, 2025

(54) SRS FOR RECIPROCITY-BASED JOINT DL TRANSMISSION FROM MULTIPLE TRPs

(71) Applicant: Telefonaktiebolaget LM Ericsson (publ), Stockholm (SE)

(72) Inventors: Shiwei Gao, Nepean (CA); Andreas Nilsson, Göteborg (SE); Sven Jacobsson, Västra Frölunda (SE); Siva Muruganathan, Stittsville (CA)

(21) Appl. No.: 18/859,644

(22) PCT Filed: Apr. 28, 2023
(86) PCT No.: PCT/IB2023/054445

§ 371 Date: Oct. 24, 2024

Related U.S. Application Data
(60) Provisional application No. 63/336,760, filed on Apr. 29, 2022.

(51) Int. Cl. H04W 52/32; H04W 52/14

(52) U.S. Cl. CPC H04W 52/325; H04W 52/146

(57) ABSTRACT

Embodiments are disclosed for Sounding Reference Signal (SRS) uplink power control in case of multiple Transmission and Reception Points (TRPs). In one embodiment, a method in a User Equipment (UE) comprises receiving information that configures first and second SRS resource/resource sets with first and second SRS sequences and first and second sets of power control parameters, respectively, wherein the first and second SRS resources/resource sets are associated with a same set of UE antenna ports. The method further comprises transmitting, at a first instant(s), a first SRS using the first SRS resource/resource set with the first SRS sequence at a first uplink power level determined based on the first set of power control parameters and transmitting, at a second instant(s), a second SRS using the second SRS resource/resource set with the second SRS sequence at a second uplink power level determined based on the second set of power control parameters.

### RELATED APPLICATIONS

This application claims the benefit of provisional patent application Ser. No. 63/336,760, filed Apr. 29, 2022, the disclosure of which is hereby incorporated herein by reference in its entirety.

### TECHNICAL FIELD

The present disclosure relates to a cellular communications system and, more specifically, joint downlink transmission from multiple Transmission and Reception Points (TRPs) in a cellular communications system and associated Sounding Reference Signal (SRS) transmission power control.

### BACKGROUND

The fifth generation mobile wireless communication system (5G) or new radio (NR), supports a diverse set of use cases and a diverse set of deployment scenarios. The latter includes deployment at both low frequencies (100s of Megahertz (MHz)), similar to Long Term Evolution (LTE), and very high frequencies (mm waves in the tens of Gigahertz (GHz)).

Similar to LTE, NR uses Orthogonal Frequency Division Multiplexing (OFDM) in the downlink (i.e., from a network node, or gNB, to a user equipment or UE). It is also referred to as Cyclic Prefix OFDM (CP-OFDM). In the uplink (i.e., from UE to gNB), both CP-OFDM and Discrete Fourier Transform (DFT)-spread OFDM (DFT-S-OFDM) are supported. DFT-S-OFDM is also referred to as Single Carrier Frequency Division Multiple Access (FDMA) (SC-FDMA) in LTE.

The basic NR physical resource can thus be seen as a time-frequency grid similar to the one in LTE as illustrated in FIG. 1, where each resource element corresponds to one OFDM subcarrier during one OFDM symbol interval. Although a subcarrier spacing of Δf=15 kilohertz (kHz) is shown in FIG. 1, different subcarrier spacing values are supported in NR. The supported subcarrier spacing values (also referred to as different numerologies) in NR are given by Δf=(15×2^{μ}) kHz where u is a non-negative integer.

Furthermore, the resource allocation in LTE is typically described in terms of resource blocks, where a resource block corresponds to one slot (0.5 milliseconds (ms)) in the time domain and twelve contiguous subcarriers in the frequency domain. Resource blocks are numbered in the frequency domain, starting with 0 from one end of the system bandwidth. For NR, a resource block refers to twelve consecutive subcarriers in the frequency domain.

In the time domain, downlink and uplink transmissions in NR are organized into equally sized slots similar to LTE as shown in FIG. 2 for 15 kHz subcarrier spacing. In NR, a subframe length is 1 ms for all supported numerologies. A subframe is further divided into a number of slots of equal duration. There are two slots per subframe for 15 kHz subcarrier spacing as in LTE. For subcarrier spacing greater than 15 kHz, there are more than two slots per subframe. For convenience, subframe is used throughout the following sections. However, it is understood that a subframe may be further divided into a number of slots and the discussions based on subframes are equally applicable to slots.

Downlink transmissions can be dynamically scheduled, i.e., in each subframe the gNB transmits downlink control information (DCI) about which UE data is to be transmitted to and which resource blocks in a downlink subframe the data is transmitted on. This control signaling is typically transmitted in the first one or two OFDM symbols in each slot in NR. The control information is carried on Physical Control Channel (PDCCH) and data is carried on Physical Downlink Shared Channel (PDSCH). A UE first detects and decodes PDCCH and if a PDCCH is decoded successfully, it then decodes the corresponding PDSCH based on the decoded control information in the PDCCH.

Uplink data transmission can also be dynamically scheduled using PDCCH. Similar to downlink, a UE first decodes uplink grants carried in PDCCH and then transmits data over the Physical Uplink Shared Channel (PUSCH) based the decoded control information in the uplink grant such as modulation order, coding rate, uplink resource allocation, and etc.

In addition to PUSCH, Physical Uplink Control Channel (PUCCH) is also supported in NR to carry uplink control information (UCI) such as HARQ (Hybrid Automatic Repeat Request) related Acknowledgement (ACK), Negative Acknowledgement (NACK), or Channel State Information (CSI) feedback.

1 Downlink Transmission with CSI Feedback

In NR, channel state information (CSI) reference signal (RS) is used for measuring and feedback downlink CSI. By measuring on a CSI-RS, a UE can estimate the effective channel, including the downlink radio propagation channel and both transmit and receive antenna gains, the CSI-RS has traversed. In more mathematical rigor, this implies that if a known RS signal xⱼ (j=1, 2, . . . , Nₜₓ) is transmitted on the jth transmit antenna port of a base station at a time-frequency resource element, the received signal yᵢ (i=1, 2, . . . , Nᵣₓ) on the ith receive antenna port of a UE at the same time-frequency resource element can be expressed as

$${y}_{i} = {h}_{i , j} {x}_{j} + {n}_{i}$$

where h_{i,j} is the effective channel between the jth transmit (Tx) antenna port and the ith receive (Rx) antenna port at the time-frequency resource element, nᵢ is the receiver noise associated with the ith receive antenna port, Nₜₓ is the number of transmit antenna ports at the base station and Nᵣₓ is the number of receive antenna ports at the UE.

A UE can estimate the Nᵣₓ×Nₜₓ effective channel matrix H(H(i,j)=h_{i,j}) for each time-frequency element over which the CSI-RS is transmitted. The effective channel can thus be estimated over a Physical Resource Block (PRB), a subband, or a whole bandwidth part (BWP).

CSI typically comprises a rank indicator (RI), a precoding matrix indicator (PMI), and a channel quality indicator (CQI). RI is used to indicate the number of spatial layers available to carry multiple data streams, one per layer, simultaneously in a same time-frequency resource over the channel. PMI is used to indicate a best precoding matrix to be applied to the multiple data streams before transmitting over the Tx antennas. CQI is used to indicate the modulation and coding scheme (MCS) that can be used for a codeword with the given RI and PMI to achieve certain block error rate (BLER).

### 2 Downlink Transmission Based on Channel Reciprocity

Sounding reference signal (SRS) is typically used for uplink channel measurements for the purpose of uplink (UL) scheduling and link adaption, in which an SRS is sent by a UE and the UL channel is measured by the gNB to determine the UL CSI. In time division duplexing (TDD) systems, the downlink (DL) and UL channels are reciprocal and, thus, SRS can also be used to obtain DL CSI, or at least DL PMI. Compared to CSI-RS based DL CSI feedback, this saves CSI feedback overhead and also potentially reduces feedback latency.

### 3 SRS

Similar to LTE, configurable SRS bandwidth is supported in NR. SRS can be configurable with regard to density in frequency domain (e.g., indicated by comb) and/or in time domain (including multi-symbol SRS transmissions).

A UE can be configured with one or more SRS resource sets, where each SRS resource set can contain one or more SRS resources. Each SRS resource can contain Nₐₚ^{SRS} ∈{1,2,4} SRS antenna ports in a time-frequency resource with N_{symb}^{SRS} ∈{1,2,4,8,10,12,14} consecutive OFDM symbols in a slot starting from OFDM symbol l₀ and a number of PRBs starting from subcarrier k₀.

An SRS sequence for an SRS antenna port pᵢ at OFDM symbol l′ in an SRS resource is a cyclic shifted version of a Zadoff-Chu sequence T_{u,v}(n) with a group number u∈{0,1, . . . ,29} and a base sequence number v∈{0,1} within the group, i.e.,

$${r}^{( {p}_{i} )} ( n , {l}^{′} ) = {r}_{u , v}^{( {α}_{i} , δ )} ( n ) = {e}^{j α n} {\overline{r}}_{u , v} ( n ) ,$$

$$0 \leq n < {M}_{ZC}$$

$${l}^{′} ∈ \{ 0 , 1 , … , {N}_{symb}^{SRS} - 1 \}$$

where M_{zc}=mN_{sc}^{RB}/2^{δ} is the length of the SRS sequence, m is the number of RBs configured for the SRS resource, N_{sc}^{RB}=12 is the number sub-carriers per RB, δ=log, (K_{Tc}) and K_{TC} ∈{2,4,8} is a configured comb value where the SRS sequence occupies every K_{TC} sub-carriers,

$${α}_{i} = 2 π \frac{{n}_{SRS}^{cs , i}}{{n}_{SRS}^{cs , max}}$$

is a cyclic shift and n_{sRS}^{cs,max} is maximum number of cyclic shifts that can be configured as shown in Table 6.4.1.4.2-1 in 3GPP TS 38.211 V17.0.0 and n_{sRS}^{cs,i} ∈{0,1, . . . , n_{SRS}^{cs,max}-1}, which is reproduced herein as Table 1.

TABLE 1
Reproduction of Table 6.4.1.4.2-1 (“Maximum number of
cyclic shifts n_{SRS}^{cs, max} as a function of K_{TC}.”)

| K_{TC} | n_{SRS}^{cs, max} |
|---|---|
| 2 | 8 |
| 4 | 12 |
| 8 | 6 |

In case of two SRS ports contained in a SRS resource, the two SRS ports are mapped to the same comb offset but allocated with two different cyclic shifts separated by π. In case of four SRS ports contained in a SRS resource, two possible port-allocation options are supported unless the transmission comb is 8 (supported since NR Rel-17) for which only the second option is supported. In the first option, the four SRS ports are mapped to the same comb offset but allocated four different cyclic shifts separated by π/2. In the second option, the first two SRS ports are allocated with two different cyclic shifts separated by π on a same set of sub-carriers (with a same first comb offset) and the last two SRS ports are allocated with the same two different cyclic shifts as the first two SRS ports but on a different set of sub-carriers (with a same second comb offset).

The definition of the base sequence r̅_{u,v} (0), . . . , r̅_{u,v} (M_{zc}-1) depends on the sequence length M_{zc} and is described in section 5.2.2 of 3GPP TS 38.211 V17.0.0. M_{zc}=M_{sc,b}^{SRS}-1 and M_{sc,b}^{SRS} is the number of subcarriers configured for the SRS resource.

In NR, the sequence group u is given by

$$u = ( {f}_{gh} ( {n}_{s , f}^{μ} , {l}^{′} ) + {n}_{ID}^{SRS} ) mod 30$$

where n_{ID}^{SRS} ∈{0, 1, . . . , 1023} is configured by higher layers, and n_{s,f}^{μ}, is the slot number in a radio frame.

### 3.1 SRS Group and Sequence Hopping

If both group and sequence hopping are disabled, then

$${f}_{gh} ( {n}_{s , f}^{μ} , {l}^{′} ) = 0$$

$$v = 0$$

If group hopping is enabled and sequence hopping is disabled

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30$$

$$v = 0$$

where the pseudo-random sequence c(i) is defined in section 5.2.1 of 3GPP TS 38.211 V17.0.0 and shall be initialized with Cᵢₙᵢₜ=n_{ID}^{SRS} at the beginning of each radio frame, and N_{symb}^{slot} is the number of OFDM symbols in a slot.

If sequence hopping is enabled and group hopping is disabled

$${f}_{gh} ( {n}_{s , f}^{μ} , {l}^{′} ) = 0$$

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

where the pseudo-random sequencec(i) is defined in section 5.2.1 of 3GPP TS 38.211 V17.0.0 and shall be initialized with Cᵢₙᵢₜ=n_{ID}^{SRS} at the beginning of each radio frame.

For UEs in the same serving cell, a same SRS sequence ID, n_{ID}^{SRS}, is typically allocated for all UEs such that SRS ports allocated at the same time-frequency resource are orthogonal. For UEs in different cells, different SRS sequences are typically configured so that inter-cell SRS interferences are randomized.

### 3.2 SRS Bandwidth

In general, two kinds of sounding bandwidths are supported, one is wideband, and the other is narrowband. In case of wideband, channel measurement over a large system bandwidth can be performed in a single OFDM symbol. While in narrowband sounding, only part of the full bandwidth can be measured in each OFDM symbol, thus multiple SRS OFDM symbols are needed for a full bandwidth channel measurement. Frequency hopping is supported for narrowband SRS so that different parts of the full bandwidth can be measured in different SRS OFDM symbols.

The SRS bandwidth for a UE is configurable and is in the multiple of 4 PRBs. The minimum SRS bandwidth is 4 PRBs, which is also referred to as SRS subband. An example is shown in FIG. 3.

In case of narrowband SRS with frequency hopping (FH), an SRS is transmitted on different part of the system bandwidth at different SRS OFDM symbols. For example, for a 10 MHz system, with 15 kHz subcarriers spacing, and SRS bandwidth of 4 PRBs, a possible set of locations in the frequency domain for SRS transmission are shown in FIG. 4. In this example, the whole bandwidth can be measured after 12 SRS OFDM symbols.

Different UEs can be multiplexed on the same time-frequency resources by assigning different cyclic shifts. In addition, an SRS signal is only transmitted on a subset of the subcarriers in the configured SRS bandwidth (i.e., every K_{Tc} subcarriers), configurable through a parameter called comb, thereby increasing the SRS multiplexing capacity provided that the channel is sufficiently flat so that channel measurement every K_{TC} subcarriers is adequate and so that ports assigned to different cyclic shifts are not interfering with each other.

### 3.3 SRS Resource Types

An SRS resource can be periodic, semi-persistent, or aperiodic. In case of periodic or semi-persistent SRS, a UE transmits SRS periodically at certain configured SRS slots. In case of aperiodic SRS, a UE transmits SRS only when it is requested by eNB.

### 3.4 SRS Power Control

SRS power control is used to determine a proper SRS transmit power such that the SRS is received at a desired power level at the gNB. This is needed to ensure SRS from all UEs in a same cell are received at approximately a same power level at the gNB to avoid cross UE interference.

SRS power control in NR consists of two parts, i.e., open-loop power control and

closed-loop power control. Open-loop power control is used to set the uplink transmit power based on a pathloss estimation and some other factors including the target receive power, SRS bandwidth, fractional power control factor, etc.

Closed-loop power control is based on explicit power control commands received from the gNB. The power control commands are used to adjust the SRS transmit power based on actual received SRS power at the gNB. Either cumulative or non-cumulative closed-loop power adjustments are supported in NR. A closed loop adjustment at a given time is also referred as a power control adjustment state.

Pathloss estimation is based on a downlink (DL) reference signal (RS). Such an DL RS is referred to as a pathloss reference RS. A DL pathloss reference RS can be a CSI-RS or Synchronization Signal and Physical Broadcast Channel Block (SSB).

For an SRS in an SRS resource set qₛ associated with a pathloss reference RS with index k, the transmit power for the SRS in a transmission occasion i within a slot in a bandwidth part (BWP) of a carrier frequency of a serving cell and a closed-loop indexl(l=0,1) can be expressed as

$$P ( i , k , l , {q}_{s} ) = min \{ \begin{matrix}{P}_{CMAX} ( i ) \\ {P}_{open - loop} ( i , k , {q}_{s} ) + {P}_{closed - loop} ( i , l )\end{matrix}$$

where P_{CMAX}(i) is the configured UE maximum output power for the carrier frequency of the serving cell in transmission occasion i. Here, Pₒₚₑₙ₋ₗₒₒₚ (i,k) is the open loop power adjustment and P_{closed-loop} (i,l) is the closed loop power adjustment. Pₒₚₑₙ₋ₗₒₒₚ (i, k, qₛ) is given as:

$${P}_{open - loop} ( i , k , {q}_{s} ) = {P}_{O} ( {q}_{S} ) + {P}_{RB} ( i ) + α ( {q}_{s} ) PL ( k )$$

where Pₒ (qₛ) is the nominal SRS target receive power, P_{RB} (i) is a power adjustment related to the number of RBs occupied by the SRS in a transmission occasion i, PL (k) is the pathloss estimation based on a pathloss reference RS with index k, a (qₛ) is fractional pathloss compensation factor. Pₒ (qₛ), k and a (qₛ) are configured for the SRS resource set qₛ.

For SRS closed-loop power control, a UE can have a dedicated closed loop for SRS or share a closed loop of PUSCH in the same serving cell. This is configured by a higher layer parameter srs-PowerControlAdjustmentStates in each SRS resource set to select one out of three options, i.e., use the dedicated closed loop for SRS, the first closed loop, and the second closed loop for PUSCH. In case that the closed loop(s) are shared with PUSCH, P_{closed-loop} (i,l) for PUSCH also applies to SRS transmitted in the SRS resource set.

For the dedicated closed loop configured for SRS, P_{closed-loop} (i,l) is given below:

$${P}_{closed - loop} ( i , l ) = \{ \begin{matrix}{P}_{closed - loop} ( i - {i}_{0} , l ) + {\sum }_{m = 0}^{M} δ ( m , l ) ; if cumulation is enabled \\ δ ( i , l ) ; if cumulation is disabled ( i . e . , absolute is enable )\end{matrix}$$

where δ(i,l) is a transmit power control (TPC) command value received in DCI format 2.3 associated with the SRS at transmission occasion i and closed-loop index l; Σₘ₌₀^{M}, δ(m,l) is a sum of TPC command values that the UE receives for the SRS and the associated closed-loop index l since the TPC command for transmission occasion i−i₀.

### 3.5 SRS for Antenna Switching

When a UE has more receive branches than transmit branches, only a subset of antenna ports is used for UL transmission. The full DL channel cannot be obtained based on SRS transmission on the subset of antenna ports.

One way to solve the problem is antenna switching, in which SRS is transmitted in different subsets of antenna ports at different times. This is commonly referred to as xTyR antenna switching, i.e., x transmit and y receive branches, where y=mx and m is an integer.

An example is shown in FIG. 5, where there are four antennas and one transmit chain, i.e., 1T4R. The full channel associated with the four antennas are sounded by transmitting a single port SRS on one antenna port at a time over four OFDM symbols using an antenna switch after each OFDM symbol. In this example, the four OFDM symbols are spread over two slots. For that, two SRS resource sets need to be configured, one set for each of the two slots. Each of the two SRS resource sets contains two single port SRS resources on two different OFDM symbols. The two SRS resource sets are triggered together. The same power control parameters need to be configured for the two SRS resource sets.

In general, for xTyR, full channel sounding can be achieved by transmitting SRS over x antenna ports at each OFDM symbol and over m OFDM symbols. If the m OFDM symbols are within a same slot, a single SRS resource set with m=y/x SRS resources can be configured. If the m OFDM symbols are spread in z different slots, z SRS resource sets each with y/(x*z) SRS resources can be configured.

4 Joint DL Transmission from Multiple TRPs

Non-coherent joint DL PDSCH transmission (NC-JT) is supported in NR Rel-16 in which a subset of layers of a PDSCH can be transmitted from a first Transmission and Reception Point (TRP) and the rest of layers of the PDSCH can be transmitted from a second TRP. An example is shown in FIG. 6, where layer 1 of a PDSCH is transmitted from TRP1 while layer 2 of the PDSCH is transmitted from TRP2. When multiple antenna ports are deployed at each TRP, a precoding matrix would be applied to the PDSCH at each TRP, e.g., w₁ at TRP1 and w₂ at TRP2. The two TRPs may be in different physical locations.

In NR Rel-18, coherent joint PDSCH transmission (CJT) from multiple TRPs is to be introduced in which a PDSCH layer can be transmitted from up to four TRPs. An example is shown in FIG. 7, where a same PDSCH layer is transmitted over two TRPs. When multiple antenna ports are deployed at each TRP, a precoding matrix would be applied to the PDSCH at each TRP. In addition, a co-phasing factor is also applied so that the PDSCH from the two TRPs are phase synchronized and thus can be coherently combined at the UE.

### SUMMARY

Systems and methods are disclosed that relate to uplink power control for Sounding Reference Signal (SRS) transmission in case of reciprocity based joint downlink transmission from multiple Transmission and Reception Points (TRPs). In one embodiment, a method performed by a User Equipment (UE) comprises any one or more of the following actions. The UE receives, from a network node, information that configures the UE with a first SRS resource or resource set with a first SRS sequence and a first set of power control parameters and a second SRS resource or resource set with a second SRS sequence and a second set of power control parameters, wherein the first SRS resource or resource set and the second SRS resource or resource set are associated with a same set of antenna ports of the UE. In response to a trigger or request to transmit SRS associated to one or both the first SRS resource or resource set and the second SRS resource or resource set, the UE performs a number of actions. In particular, the UE determines, based on the first set of power control parameters, a first uplink power level for transmitting a first SRS using the first SRS resource or resource set with the first SRS sequence, and transmits, at a first time instant(s), the first SRS using the first SRS resource or resource set with the first SRS sequence at the first uplink power level. The UE also determines, based on the second set of power control parameters, a second uplink power level for transmitting a second SRS using the second SRS resource or resource set with the second SRS sequence, and transmits, at a second time instant(s) that is different than the first time instant(s), the second SRS using the second SRS resource or resource set with the second SRS sequence at the second uplink power level. In this manner, SRS transmission power is controlled such that SRS interference across different TRPs is reduced without increasing SRS overhead, compared to the baseline case where a same SRS sequence is configured across the different TRPs.

In one embodiment, the first time instant(s) is a first Orthogonal Frequency Division Multiplexing (OFDM) symbol(s) and the second time instant(s) is a second OFDM symbol(s) wherein the first OFDM symbol(s) and the second OFDM symbol(s) are not the same OFDM symbol(s).

In one embodiment, the first time instant(s) is in a first time slot and the second time instant(s) is in a second time slot wherein the first time slot and the second time slot are not a same time slot.

In one embodiment, the first SRS resource or resource set and the second SRS resource or resource set are configured for downlink channel state information (CSI) acquisition.

In one embodiment, the first SRS resource or resource set and the second SRS resource or resource set are configured with a parameter ‘usage’ set as ‘antenna switching’.

In one embodiment, the first set of power control parameters comprise a first pathloss reference Reference Signal (RS), and the second set of power control parameters comprise a second pathloss reference RS.

In one embodiment, the first SRS resource or resource set and the second SRS resource or resource set are one of periodic, semi-persistent, and aperiodic. In one embodiment, the request is signaled in downlink control information (DCI).

Corresponding embodiments of a UE are also disclosed. In one embodiment, a UE comprises a communication interface comprising a transmitter and a receiver, and processing circuitry associated with the communication interface. The processing circuitry is configured to cause the UE to perform any one or more of the following actions. The UE receives, from a network node, information that configures the UE with a first SRS resource or resource set with a first SRS sequence and a first set of power control parameters and a second SRS resource or resource set with a second SRS sequence and a second set of power control parameters, wherein the first SRS resource or resource set and the second SRS resource or resource set are associated with a same set of antenna ports of the UE. In response to a trigger or request to transmit SRS associated to one or both the first SRS resource or resource set and the second SRS resource or resource set, the UE performs a number of actions. In particular, the UE determines, based on the first set of power control parameters, a first uplink power level for transmitting a first SRS using the first SRS resource or resource set with the first SRS sequence, and transmits, at a first time instant(s), the first SRS using the first SRS resource or resource set with the first SRS sequence at the first uplink power level. The UE also determines, based on the second set of power control parameters, a second uplink power level for transmitting a second SRS using the second SRS resource or resource set with the second SRS sequence, and transmits, at a second time instant(s) that is different than the first time instant(s), the second SRS using the second SRS resource or resource set with the second SRS sequence at the second uplink power level.

In another embodiment, a method performed by a UE comprises receiving, from a network node, information that configures the UE with a SRS resource set with two or more pathloss reference signals, determining a first uplink power level for transmission of a first SRS for the SRS resource set based on at least one of the two or more pathloss reference signals configured for the SRS resource set; and transmitting the first SRS using the first uplink power level. In this manner, SRS transmission power is controlled such that SRS interference across different TRPs is reduced without increasing SRS overhead, compared to the baseline case where a same SRS sequence is configured across the different TRPs.

In one embodiment, determining the first uplink power level for transmission of the first SRS for the SRS resource set based on the at least one of the two or more pathloss reference signals configured for the SRS resource set comprises determining the first uplink power level for transmission of the first SRS for the SRS resource set based on a first pathloss reference signal of the two or more pathloss reference signals configured for the SRS resource set. In one embodiment, the method further comprises determining a second uplink power level for transmission of a second SRS for the SRS resource set based a second pathloss reference signal of the two or more pathloss reference signals configured for the SRS resource set and transmitting the second SRS using the second uplink power level. In one embodiment, the method further comprises receiving, from the network node, a first indication that indicates the first pathloss reference signal of the two or more pathloss reference signals configured of the SRS resource set, wherein determining the first uplink power level for transmission of the first SRS for the SRS resource set based the first pathloss reference signal is responsive to receiving the first indication that indicates the first pathloss reference signal of the two or more pathloss reference signals configured of the SRS resource set. In another embodiment, the method further comprises calculating two or more pathloss values based on the two or more pathloss reference signals configured for the SRS resource set, respectively, and selecting the first pathloss reference signal to be used for determining the first uplink power level based on the two or more pathloss values. In one embodiment, selecting the first pathloss reference signal to be used for determining the first uplink power level comprises selecting, from among the two or more reference pathloss signals, a pathloss reference signal that is associated with a highest pathloss value as the first pathloss reference signal to be used for determining the first uplink power level.

In one embodiment, the method further comprises calculating two or more pathloss values based on the two or more pathloss reference signals configured for the SRS resource set, respectively, and calculating an average pathloss value based on two or more pathloss values, wherein determining the first uplink power level for transmission of the first SRS for the SRS resource set based on the at least one of the two or more pathloss reference signals configured for the SRS resource set comprises determining the first uplink power level for transmission of the first SRS for the SRS resource set based on the average pathloss value.

Corresponding embodiments of a UE are also disclosed. In one embodiment, a UE comprises a communication interface comprising a transmitter and a receiver, and processing circuitry associated with the communication interface. The processing circuitry is configured to cause the UE to receive, from a network node, information that configures the UE with a SRS resource set with two or more pathloss reference signals, determine a first uplink power level for transmission of a first SRS for the SRS resource set based on at least one of the two or more pathloss reference signals configured for the SRS resource set, and transmit the first SRS using the first uplink power level.

In another embodiment, a method performed by a UE comprises receiving, from a network node, information that configures the UE with a SRS resource set with two or more pathloss reference signals and transmitting one or more SRSs using the SRS resource set, wherein the one or more SRSs are transmitted such that either: (a) different uplink power levels based on the two or more pathloss reference signals are applied for different OFDM symbols of each SRS resource in the SRS resource set or (b) the UE sequentially sweeps through different uplink power levels that are based on the two or more pathloss reference signals for different SRS transmission occasions. In this manner, SRS transmission power is controlled such that SRS interference across different TRPs is reduced without increasing SRS overhead, compared to the baseline case where a same SRS sequence is configured across the different TRPs.

Corresponding embodiments of a UE are also disclosed. In one embodiment, a UE comprises a communication interface comprising a transmitter and a receiver, and processing circuitry associated with the communication interface. The processing circuitry is configured to cause the UE to receive, from a network node, information that configures the UE with a SRS resource set with two or more pathloss reference signals and transmit one or more SRSs using the SRS resource set, wherein the one or more SRSs are transmitted such that either: (a) different uplink power levels based on the two or more pathloss reference signals are applied for different OFDM symbols of each SRS resource in the SRS resource set or (b) the UE sequentially sweeps through different uplink power levels that are based on the two or more pathloss reference signals for different SRS transmission occasions.

Embodiments of a method performed by a network node are also disclosed. In one embodiment, a method performed by a network node comprises transmitting, to a UE, information that configures the UE with a first SRS resource or resource set with a first SRS sequence and a first set of power control parameters and a second SRS resource or resource set with a second SRS sequence and a second set of power control parameters, wherein the first SRS resource or resource set and the second SRS resource or resource set are associated with a same set of antenna ports of the UE and the first SRS resource or resource set and the second SRS resource or resource set are scheduled to be transmitted in different time instants.

In one embodiment, the first time instant is a first OFDM symbol(s) and the second time instant(s) is a second OFDM symbol(s) wherein the first OFDM symbol(s) and the second OFDM symbol(s) are not the same OFDM symbol(s).

In one embodiment, the first time instant(s) is in a first time slot and the second time instant(s) is in a second time slot wherein the first time slot and the second time slot are not the same time slot.

In one embodiment, the first SRS resource or resource set and the second SRS resource or resource set are configured for downlink channel state information, CSI, acquisition with a higher layer parameter ‘usage” set as ‘antenna switching’.

Corresponding embodiments of a network node are also disclosed. In one embodiment, a network node for a cellular communications system comprises processing circuitry configured to cause the network node to transmit, to a UE, information that configures the UE with a first SRS resource or resource set with a first SRS sequence and a first set of power control parameters and a second SRS resource or resource set with a second SRS sequence and a second set of power control parameters, wherein the first SRS resource or resource set and the second SRS resource or resource set are associated with a same set of antenna ports of the UE and the first SRS resource or resource set and the second SRS resource or resource set are scheduled to be transmitted in different time instants.

In another embodiment, a method performed by network node of a cellular communications system comprises transmitting, to a UE, information that configures the UE with a SRS resource set with two or more pathloss reference signals.

Corresponding embodiments of a network node are also disclosed. In one embodiment, a network node for a cellular communications system comprises processing circuitry configured to cause the network node to transmit, to a UE, information that configures the UE with a SRS resource set with two or more pathloss reference signals.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a time-frequency grid showing the basic New Radio (NR) resource;

FIG. 2 illustrates the time-domain structure for downlink and uplink transmissions in NR;

FIG. 3 illustrates an example Sounding Reference Signal (SRS) bandwidth;

FIG. 4 illustrates a possible set of locations in the frequency domain for SRS transmissions;

FIG. 5 illustrates an example of SRS antenna switching;

FIG. 6 illustrates an example of Non-Coherent Joint downlink Physical Downlink Shared Channel (PDSCH) Transmission (NC-JT) as supported in NR;

FIG. 7 illustrates an example of Coherent Joint PDSCH Transmission (CJT) from multiple Transmission and Reception Points (TRPs);

FIG. 8 illustrates an example of an issue regarding which TRP and associated pathloss reference signal (PL-RS) should be configured or used for SRS power control in the case of reciprocity-based downlink joint transmission from multiple TRPs;

FIG. 9 illustrates an example of configuration of separate PL-RSs and SRS sequences for different TRPs, in accordance with a first embodiment of the present disclosure;

FIG. 10 illustrates the operation of a network node and a User Equipment (UE) in accordance with one example of the first embodiment of the present disclosure;

FIG. 11 illustrates the operation of a network node and a UE in accordance with one example of a second embodiment of the present disclosure;

FIG. 12 illustrates the operation of a network node and a UE in accordance with one example of a third embodiment of the present disclosure;

FIG. 13 illustrates the operation of a network node and a UE in accordance with one example of a fourth embodiment of the present disclosure;

FIG. 14 shows an example of a communication system in accordance with some embodiments of the present disclosure;

FIG. 15 shows a UE in accordance with some embodiments of the present disclosure;

FIG. 16 shows a network node in accordance with some embodiments of the present disclosure;

FIG. 17 is a block diagram of a host, which may be an embodiment of the host of FIG. 14, in accordance with various aspects described herein;

FIG. 18 is a block diagram illustrating a virtualization environment in which functions implemented by some embodiments may be virtualized; and

FIG. 19 shows a communication diagram of a host communicating via a network node with a UE over a partially wireless connection in accordance with some embodiments.

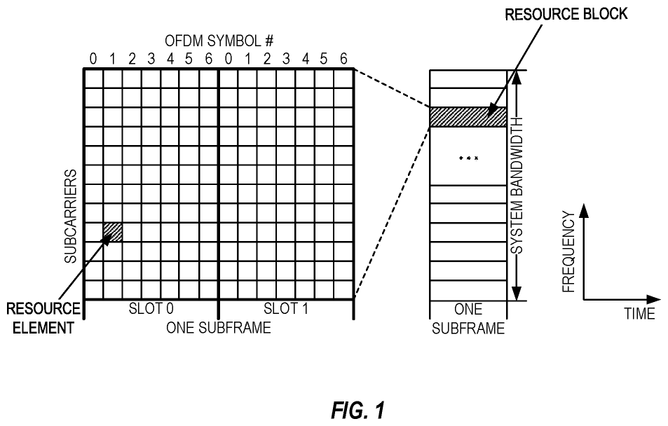

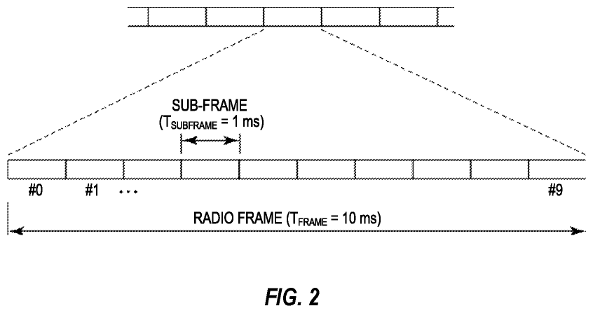

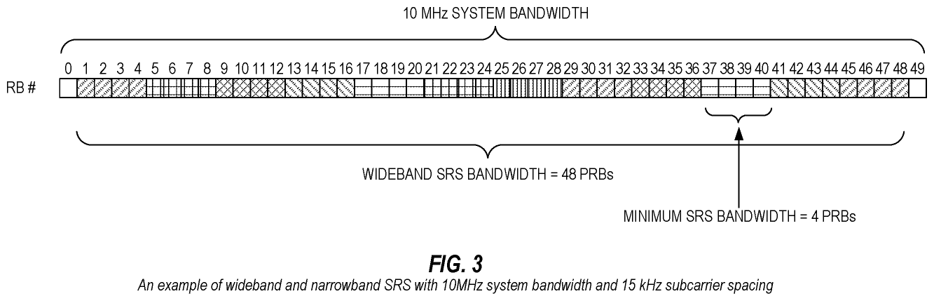

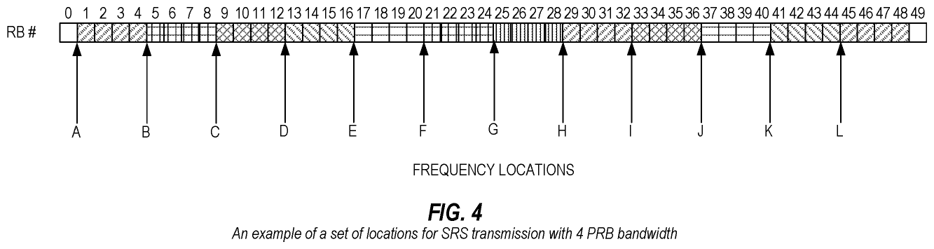

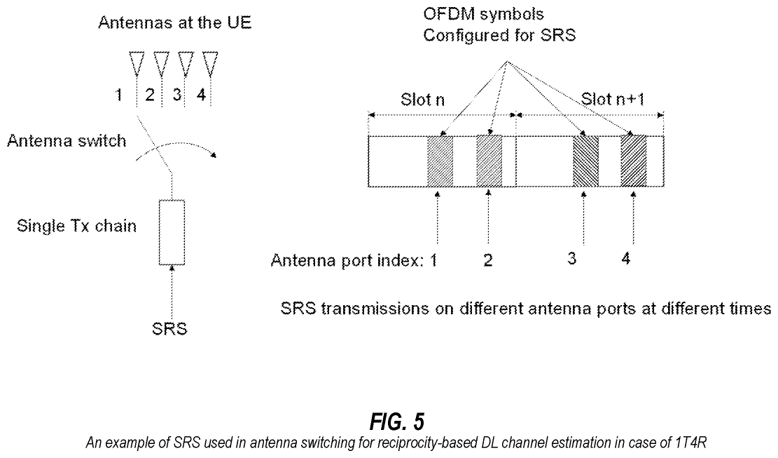

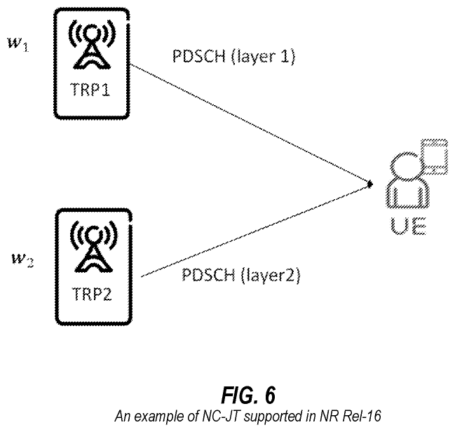

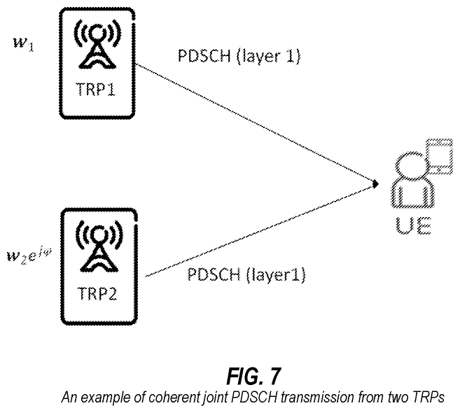

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). In case of reciprocity-based downlink (DL) joint transmission from multiple TRPs, the precoding matrices w₁ and w₂ for two TRPs are typically estimated based on uplink (UL) Sounding Reference Signals (SRSs) transmitted from the UE. When large pathloss differences exist between the UE and multiple TRPs, how to perform SRS power control is a problem. More specifically, which TRP and associated pathloss reference signal (PL-RS) should be configured/used for SRS power control is an issue.

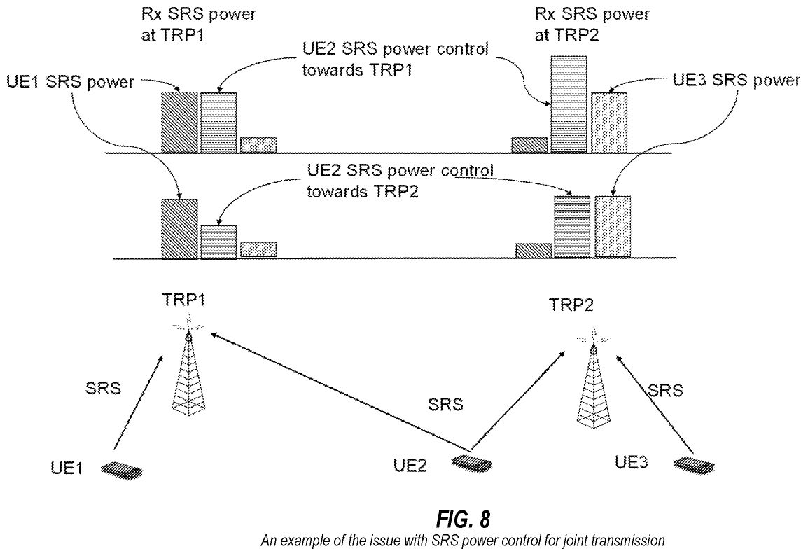

An example is shown in FIG. 8, where UE1 and UE3 are connected to TRP1 and TRP2, respectively, while UE2 is connected to both TRPs. UE1 SRS is power controlled towards TRP1 while UE3 SRS is power controlled towards TRP2. There is some SRS leakage from UE1 to TRP2 and from UE3 to TRP1, but they are very small as UE1 is far away from the TRP2 and UE3 is far away from TRP1. For UE2, it is closer to TRP2 than to TRP1. If UE2's SRS is power controlled towards TRP1, its SRS power level at TRP2 would be much higher than UE3's SRS power level at TRP2, which could introduce interference to the SRS from UE3 if both are configured with the same comb-offset value but with different cyclic shifts or if configured with a same comb-offset value but with different sequences (this holds irrespectively of which cyclic shifts are configured per UE). If UE2's SRS is power controlled towards TRP2, its SRS power level at TRP1 would be much lower than UE1, and then the SRS from UE2 would be interfered by the SRS from UE1 if both are configured with the same comb value but different cyclic shifts or configured with the same comb value and same cyclic shifts but with different sequences.

Certain aspects of the disclosure and their embodiments may provide solutions to these or other challenges. Embodiments of systems and methods are disclosed herein that support channel sounding over multiple TRPs to support reciprocity-based DL joint transmission over the multiple TRPs while reducing SRS interference among the TRPs. In one embodiment, the method comprises one of:
Configuring a UE with one or more SRS resource sets with usage ‘antenna switching’ associated with a first TRP, and one or more other SRS resource sets with usage ‘antennaSwitching’ associated with a second TRP, where different SRS sequences and different power control parameters may be configured for the SRS resource sets associated with the two TRPs (i.e. a first SRS sequence and a first set of power control parameters are associated with one or more SRS resource sets associated with the first TRP, and a second SRS sequence and a second set of power control parameters are associated with one or more SRS resource sets associated with the second TRP). The SRS resource sets associated with the first TRP contains the same SRS ports as the SRS resource sets associated with the second TRP. The SRS resource sets associated with the first TRP and the SRS resource set associated with the second TRP may be triggered together at the same time to be transmitted in different OFDM symbols or slots. OR.
Configuring a UE with one or more SRS resource sets with usage ‘antennaSwitching’ where the one or more SRS resource sets are configured with multiple path loss reference signals wherein the gNB can dynamically (e.g., using Downlink Control Information (DCI)) signal which path loss reference signal to use for the next transmission, or the UE can decide which path loss reference signal to use for the next transmission, or the UE alternates between the M configured path loss reference signals such that each of the M configured path loss reference signal are used over M SRS transmissions.

Four main embodiments are described below in detail. These embodiments are referred to herein as a “First Embodiment”, “Second Embodiment”, “Third Embodiment”, and “Fourth Embodiment”. In regard to the First Embodiment, in one embodiment, a method performed by a network node comprises:
Configuring a UE with a first SRS resource set(s) with a first SRS sequence and a first set of power control parameters and a second SRS resource set(s) with a second SRS sequence and a second set of power control parameters.
   The first and second SRS resource sets are scheduled to be transmitted in different OFDM symbols or different slots
   The first and second SRS resource sets are associated with a same SRS trigger.
   The first and second SRS resource sets are associated with same SRS ports

In regard to the Second, Third, and Fourth Embodiments, in some embodiments:
A method performed by a network node comprises configuring a UE with SRS resource set(s) with usage ‘antennaSwitching’ and configuring the SRS resource set(s) with two or more path loss reference signals.
A method performed by a UE comprises receiving, from the network node, information that configures the UE with SRS resource set(s) with usage ‘antennaSwitching’ and configures the SRS resource set(s) with two or more path loss reference signals. The method performed by the UE further comprises determining the UL output power based on the one or more configured path loss reference signals using one or more of the following methods:
   (Second Embodiment) Receive an indication in DCI triggering the SRS resource set(s), where the indication points at one of the configured path loss reference signals that the UE should use to calculate a path loss, and apply that path loss when determining the UL output power for the SRS resource set(s)
   (Third Embodiment) Calculate path loss from each of the configured path loss reference signals, determines which path loss reference signal that is associated with the highest path loss, and apply that path loss when determining the UL output power for the SRS resource set(s).
   (Third Embodiment) Calculate path loss from each of the configured path loss reference signals, determines an average path loss over all configured path loss reference signals, and apply that path loss when determining the UL output power for the SRS resource set(s).
   (Fourth Embodiment) Calculate path loss from each of the configured path loss reference signals, and apply different output power for different OFDM symbols of each SRS resources in the SRS resource set(s). For example, assume that the UE is configured with one SRS resource set with one SRS resource and the SRS resource is configured with repetition or frequency hopping over two (or more) OFDM symbols, then the UE should determine the output power for the SRS resource in the a first OFDM symbol based on a first path loss reference signal configured in the SRS resource set, and the UE should determine the output power for the SRS resource in a second OFDM symbol based on a second path loss reference signal configured in the SRS resource set.
   (Fourth Embodiment) Sequentially sweeps through the different configured path loss reference signals for different SRS transmission occasions (i.e., the first PL-RS for the first SRS transmission occasion, the second PL-RS for the second SRS transmission occasion, until all the PL-RS have been used, then start over from the first PL-RS again).

Certain embodiments may provide one or more of the following technical advantage(s). Embodiments disclosed herein reduce SRS interference across different TRPs without increasing SRS overhead, compared to the baseline case where a same SRS sequence is configured across the different TRPs.

Now, further description of the various embodiments of the present disclosure is provided. Note that while these embodiments are described under different headings, these embodiments may be used separately or in combination.

### First Embodiment: Configuring Separate Pathloss RS and SRS Sequences for Different TRPs

To reduce SRS interference between TRPs while maintaining the same SRS capacity for a given time and frequency resource, in one embodiment, different SRS sequences may be configured for UEs transmitting to different TRPs. For a UE connecting to multiple TRPs, multiple SRS resources or resource sets, one for each TRP, can be configured. Each of the multiple SRS resources or resource sets is configured with an SRS sequence and pathloss reference RS associated with the corresponding TRP. Different sequences and pathloss reference RSs may be configured for the different SRS resources or resource sets. The SRS ports in different SRS resources or resource sets are associated with the same UE antenna ports. The SRS resource sets are scheduled to be transmitted in different OFDM symbols or different slots and are associated with a same SRS trigger. Compared to legacy NR antenna-switching, each UE antenna port is sounded twice over the multiple SRS resources or resource sets.

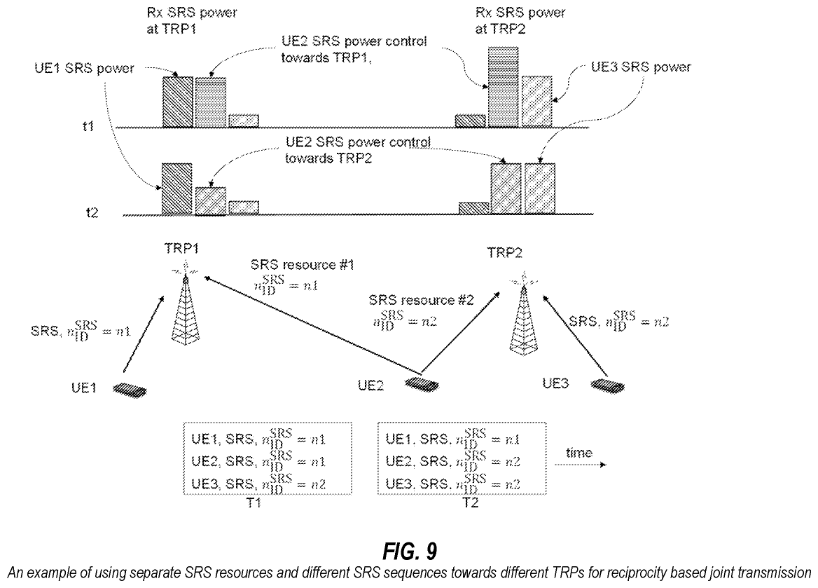

An example is shown in FIG. 9, where two TRPs and three UEs are shown. UE1 is connected to TRP1 and is configured with an SRS sequence n_{ID}^{SRS}=n1, UE3 is connected to TRP2 and is configured with an SRS sequence n_{ID}^{SRS}=n2≠n1. UE2 is connected to both TRPs and is configured with two SRS resources (or SRS resource sets), one associated with TRP1 with SRS sequence n_{ID}^{SRS}=n1 and the other associated with TRP2 with SRS sequence n_{ID}^{SRS}=n2. UE2 may transmit SRS towards TRP1 at time instance t1 and transmit SRS towards TRP2 at time instance t2. Per TRP SRS power control is used at both time instances, so that the same (or, at least, similar) received SRS power is expected from UE1 and UE2 at TRP1 at time instance t1 and from UE2 and UE3 at TRP2 at time instance t2. Note that, in this example, we have assumed that UE1 transmit SRS to TRP1 and UE3 transmit SRS to TRP2 at both time instances t1 and t2.

At time instance t1, UE2's SRS power would be higher than UE3's SRS power at TRP2. However, since different SRS sequences (i.e., n_{ID}^{SRS}=n1 and n_{ID}^{SRS}=n2) are used by UE2 and UE3, UE2's SRS at TRP2 can be treated as pseudo-white noise after receiver-side processing matched to SRS sequence n_{ID}^{SRS}=n2. Therefore, the impact on UE3's SRS quality is relatively small.

At time instance t2, UE2's SRS power would be lower than UE1's SRS power at TRP1. The impact on UE1's SRS is rather small after receiver-side processing matched to SRS sequence n_{ID}^{SRS}=n1.

Comparing to the case where a same SRS sequence n_{ID}^{SRS} nip is used in both TRPs, the above configuration can support more UEs for a given time-frequency resource for SRS and a number of SRS ports per UE.

In case of antenna switching, multiple SRS resources or resource sets may be needed for each TRP, where different set of power control parameters are configured for SRS resource sets associated to different TRPs.

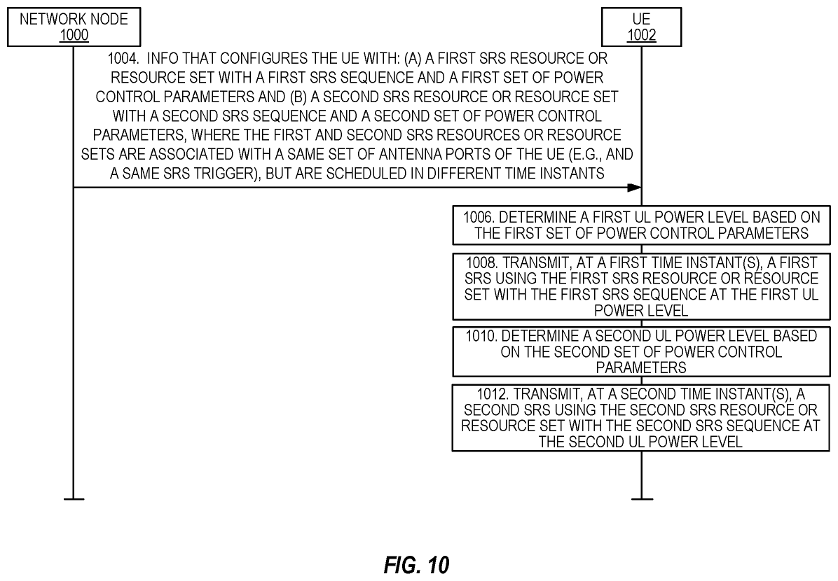

FIG. 10 illustrates the operation of a network node 1000 and a UE 1002 in accordance with one example of the First Embodiment. As illustrated, the network node 1000 transmits, to the UE 1002, information that configures the UE 1002 with a first SRS resource or resource set with a first SRS sequence and a first set of power control parameters and a second SRS resource or resource set with a second SRS sequence and a second set of power control parameters, wherein the first SRS resource or resource set and the second SRS resource or resource set are associated with a same set of antenna ports of the UE (step 1004). The first SRS resource or resource set and the second SRS resource or resource set are associated with a same SRS trigger, e.g., in the case of periodic SRS. Note that a same SRS trigger (for periodic SRS) or a same request to transmit SRS (for aperiodic SRS) may be used to initiate transmission of SRS associated to one or both of the first and second SRS resources or resource sets.

In response to the same SRS trigger or request for SRS transmission associated to the first and second SRS resources or resource sets, the UE 1002 determines, based on the first set of power control parameters, a first uplink power level for transmitting a first SRS using the first SRS resource or resource set with the first SRS sequence (step 1006) and transmits, at a first time instant(s), the first SRS using the first SRS resource or resource set with the first SRS sequence at the first uplink power level (step 1008). The UE 1002 also determines, based on the second set of power control parameters, a second uplink power level for transmitting a second SRS using the second SRS resource or resource set with the second SRS sequence (step 1010) and transmits, at a second time instant(s) (different from the first time instant(s)), the second SRS using the second SRS resource or resource set with the second SRS sequence at the second uplink power level (step 1012).

In one embodiment, the first SRS resource or resource set is associated to a first TRP, and the second SRS resource or resource set is associated to a second TRP.

In one embodiment, the first time instant is a first OFDM symbol and the second time instant is a second OFDM symbol wherein the first OFDM symbol and the second OFDM symbol are not the same OFDM symbol. In another embodiment, the first time instant is a first slot and the second time instant is a second slot wherein the first slot and the second slot are not the same slot.

In one embodiment, the first SRS resource or resource set and the second SRS resource or resource set are configured with usage ‘antenna switching’.

### Second Embodiment: Configuring Multiple Path Loss Reference Signals in an SRS Resource Set(s) and DCI Indication of One of the Multiple Path Loss Reference Signals

In the following embodiments, it is assumed that each SRS resource set is configured with more than one path loss reference signal. For example, a new field can be introduced per SRS resource set in SRS Config IE as specified in 3GPP TS 38.331, where up to N path loss reference signals can be configured.

In one embodiment, the UE receives an indication in the DCI triggering of an aperiodic SRS resource set, where the indication points at one of the configured (e.g., RRC configured) path loss reference signals. The UE should then use the indicated path loss reference signal when calculating the UL output power for the DCI-triggered transmission of the aperiodic SRS resource set. In one embodiment, an implicit indication is used to indicate which path loss reference signal the UE should use. For example, different SRS trigger states might be associated with different path loss reference signals, and for example if the SRS resource set is triggered by a first SRS trigger state, the UE should use a first configured (e.g., first RRC configured) path loss reference signal, if the same SRS resource set is trigger by a second SRS trigger state, the UE should use the second configured (e.g., second RRC configured) path loss reference signal.

In an alternative embodiment, the UE receives an indication in the DCI triggering an aperiodic SRS resource set, where the indication points at multiple configured (e.g., multiple RRC configured) path loss reference signals (i.e., one path loss reference signal per TRP). The UE then uses the indicated multiple path loss reference signals and calculates the UL output powers for the DCI-triggered multiple transmissions of the aperiodic SRS resource set towards the multiple TRPs. For instance, the first transmission of the aperiodic SRS resource set triggered by the DCI uses the UL output power corresponding to a first path loss reference signal indicated. The second transmission of the aperiodic SRS resource set triggered by the same DCI uses the UL output power corresponding to a second path loss reference signal. In some cases, the indication may be implicit where a single SRS trigger state is associated with multiple path loss reference signals.

In one embodiment, a new bitfield is introduced in DCI which explicitly indicates which of the configured (e.g., RRC configured) path loss reference signals the UE should use. This new DCI field could be linked to an SRS resource of any type (i.e., periodic, semi-persistent, aperiodic). For example, in case two path loss reference signals are configured in an SRS resource set, the new bitfield could consist of one bit, and where a first codepoint indicates to use the first path loss reference signal, and a second codepoint indicates to use the second path loss reference signal.

In another alternative embodiment, a new bitfield is introduced in DCI which explicitly indicates one or multiple of the configured (e.g., RRC configured) pathloss reference signals the UE should use (one path loss reference signal per TRP). If a codepoint in this new bitfield is associated with a single path loss reference signal, then the SRS resource set is transmitted using the indicated single path loss reference signal towards one of the TRPs. If a codepoint in this new bitfield is associated with multiple path loss reference signals, then the SRS resource set is transmitted multiple times where each of the multiple transmissions corresponds to one of the multiple pathloss reference signals indicated by the codepoint in the new bitfield.

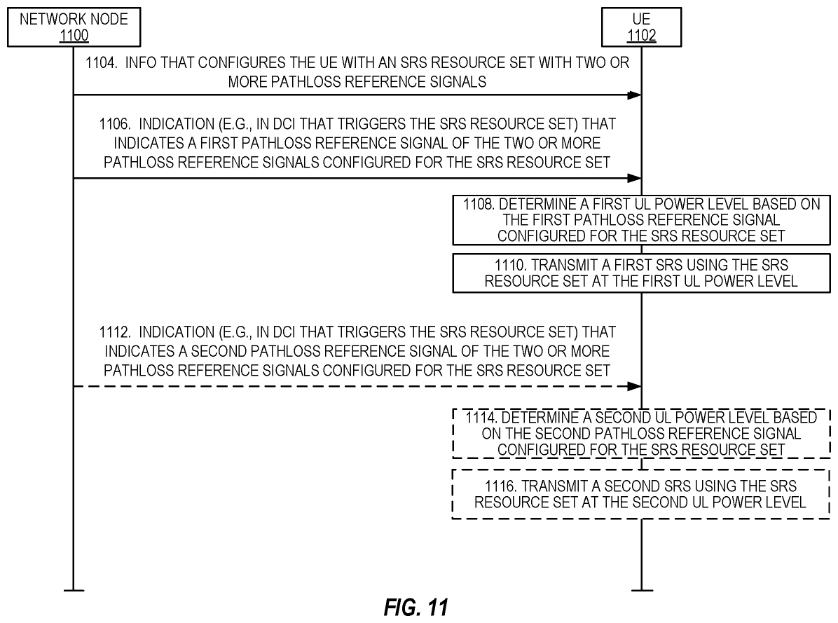

FIG. 11 illustrates the operation of a network node 1100 and a UE 1102 in accordance with one example of the Second Embodiment. Optional steps are represented by dashed lines/boxes. As illustrated, the network node 1100 transmits, to the UE 1102, information that configures the UE 1102 with an SRS resource set with two or more pathloss reference signals (step 1104). The UE 1102 determines a first uplink power level for transmission of a first SRS for the SRS resource set based on at least one of the two or more pathloss reference signals configured for the SRS resource set. More specifically, in this example, the UE 1102 receives, from the network node 1100, a first indication (e.g., in a first DCI that triggers the SRS resource set) that indicates the first pathloss reference signal of the two or more pathloss reference signals configured of the SRS resource set (step 1106). The UE 1102 determines a first uplink power level based on the indicated first pathloss reference signal (step 1108) and transmits a first SRS using the SRS resource set at the first UL power level (1110).

The UE 1102 may also receive, from the network node 1100, a second indication (e.g., in DCI that triggers the SRS resource set) that indicates a second pathloss reference signal of the two or more pathloss reference signals configured for the SRS resource set (step 1112). The UE 1102 may then determine a second uplink power level based on the indicated second pathloss reference signal (step 1110) and transmit a second SRS using the SRS resource set at the second UL power level (1112).

### Third Embodiment: Configuring Multiple Path Loss Reference Signals in an SRS Resource Set(s) and UE Deciding which Path Loss Reference Signal to Use

In one embodiment, the UE calculates the path loss from all the configured path loss reference signals in an SRS resource set, determines which path loss reference signal that is associated with the highest path loss, and apply that path loss when determining the UL output power for that SRS resource set.

In one embodiment, the UE calculates the path loss from each of the configured path loss reference signals, determines an average path loss over all configured path loss reference signals, and apply that path loss when determining the UL output power for that SRS resource set. In one alternate of this embodiment, the average path loss is calculated as the linear average path loss over all path loss reference signal. In another alternate of this embodiment, the average path loss is calculated by averaging over the all the path loss from all the path loss reference signals in dB scale (so for example if a first path loss value associated with a first path loss reference signal is 100 dB, and a second path loss value associated with a second path loss reference signal is 110 dB, then the average path loss reference signal in this case is 105 dB, i.e. (100+110)/2.

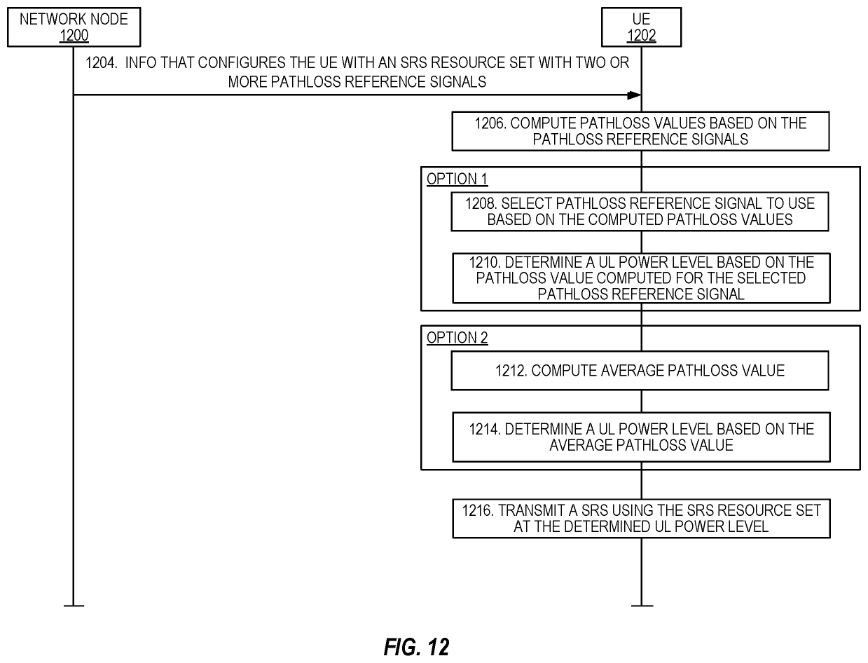

FIG. 12 illustrates the operation of a network node 1200 and a UE 1202 in accordance with one example of the Third Embodiment. Optional steps are represented by dashed lines/boxes. As illustrated, the network node 1200 transmits, to the UE 1202, information that configures the UE 1202 with an SRS resource set with two or more pathloss reference signals (step 1204). The UE 1202 determines a first uplink power level for transmission of a first SRS for the SRS resource set based on at least one of the two or more pathloss reference signals configured for the SRS resource set. More specifically, in this example, the UE 1102 computes pathloss values for the two or more pathloss reference signals configured for the SRS resource set (step 1206). Then, there are two alternative options, which are referred to herein as Option 1 and Option 2.

For Option 1, the UE 1202 selects one of the two or more pathloss reference signals based on the computed pathloss values (step 1208). In one embodiment, the selected pathloss reference signal is the one that corresponds to the largest pathloss value. The UE 1202 then determines the uplink power level for transmission of an SRS based on the selected pathloss reference signal (e.g., based on the pathloss value computed for the selected pathloss reference signal) (step 1210).

For Option 2, the UE 1202 computes an average pathloss value based on the computed pathloss values (step 1212). The UE 1202 then determines the uplink power level for transmission of an SRS based on the average pathloss value (step 1212).

### Fourth Embodiment: Configuring Multiple Path Loss Reference Signals in an SRS Resource Set(s) and UE Alternating Between Path Loss Reference Signals

In one embodiment, the UE calculates the path loss from each of the configured path loss reference signals and applies different output power for different OFDM symbols of each SRS resources in the SRS resource set(s). For example, assume that the UE is configured with one SRS resource set with one SRS resource, and the SRS resource is configured with repetition or frequency hopping over two OFDM symbols, then the UE should determine the output power for the SRS resource in the first OFDM symbol based on a first path loss reference signal configured in the SRS resource set, and the UE should determine the output power for the SRS resource in the second OFDM symbol based on a second path loss reference signal configured in the SRS resource set.

In one embodiment, the UE sequentially sweeps through the different configured (e.g., RRC configured) path loss reference signals for different SRS transmission occasions. For example, assume that a UE is configured with an SRS resource set with two path loss reference signals. Then in a first SRS transmission occasion, the UE should apply the first path loss reference signal when determining the SRS output power; for the next SRS transmission occasion, the UE should apply the second path loss reference signal when determining the SRS output power; for the next SRS transmission occasion, the UE should again apply the first path loss reference signal when determining the SRS output power; and so on.

In some embodiments, the UE may be configured with a mapping pattern on how to sweep through the different configured (e.g., RRC configured) path loss reference RSs. When a first mapping pattern (e.g., sequential mapping pattern) is configured, the SRS may be transmitted in the following example pattern:
SRS Transmission with pathloss reference signal 1 used for Tx power computation on SRS port 1
SRS Transmission with pathloss reference signal 2 used for Tx power computation on SRS port 1
SRS Transmission with pathloss reference signal 1 used for Tx power computation on SRS port 2
SRS Transmission with pathloss reference signal 2 used for Tx power computation on SRS port 2
SRS Transmission with pathloss reference signal 1 used for Tx power computation on SRS port 3
SRS Transmission with pathloss reference signal 2 used for Tx power computation on SRS port 3
SRS Transmission with pathloss reference signal 1 used for Tx power computation on SRS port 4
SRS Transmission with pathloss reference signal 2 used for Tx power computation on SRS port 4
   With the above pattern, there are fewer antenna switches (i.e., antenna switching happened 3 times over 8 SRS transmissions).

When a second mapping pattern (e.g., cyclic mapping pattern) is configured, the SRS may be transmitted in the following example pattern:
SRS Transmission with pathloss reference signal 1 used for Tx power computation on SRS port 1
SRS Transmission with pathloss reference signal 1 used for Tx power computation on SRS port 2
SRS Transmission with pathloss reference signal 1 used for Tx power computation on SRS port 3
SRS Transmission with pathloss reference signal 1 used for Tx power computation on SRS port 4
SRS Transmission with pathloss reference signal 2 used for Tx power computation on SRS port 1
SRS Transmission with pathloss reference signal 2 used for Tx power computation on SRS port 2
SRS Transmission with pathloss reference signal 2 used for Tx power computation on SRS port 3
SRS Transmission with pathloss reference signal 2 used for Tx power computation on SRS port 4
   With the above pattern, there are fewer transmit power changes and also requires less number of OFDM symbols if a gap symbol is needed for transmit power changes.

FIG. 13 illustrates the operation of a network node 1300 and a UE 1302 in accordance with one example of the Fourth Embodiment. Optional steps are represented by dashed lines/boxes. As illustrated, the network node 1300 transmits, to the UE 1302, information that configures the UE 1202 with an SRS resource set with two or more pathloss reference signals (step 1304). The UE 1302 then transmits one or more SRSs using the SRS resource set, wherein the one or more SRSs are transmitted such that either: (a) different uplink power levels based on the two or more pathloss reference signals are applied for different OFDM symbols of each SRS resource in the SRS resource set or (b) the UE 1302 sequentially sweeps through different uplink power levels that are based on the two or more pathloss reference signals for different SRS transmission occasions (step 1306)

### Further Description

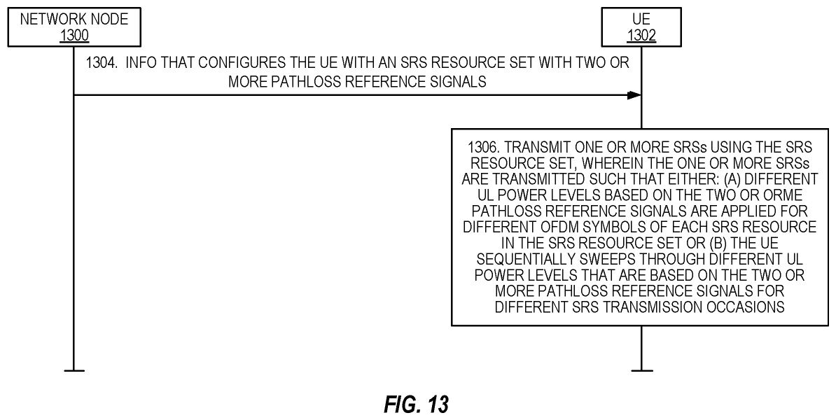

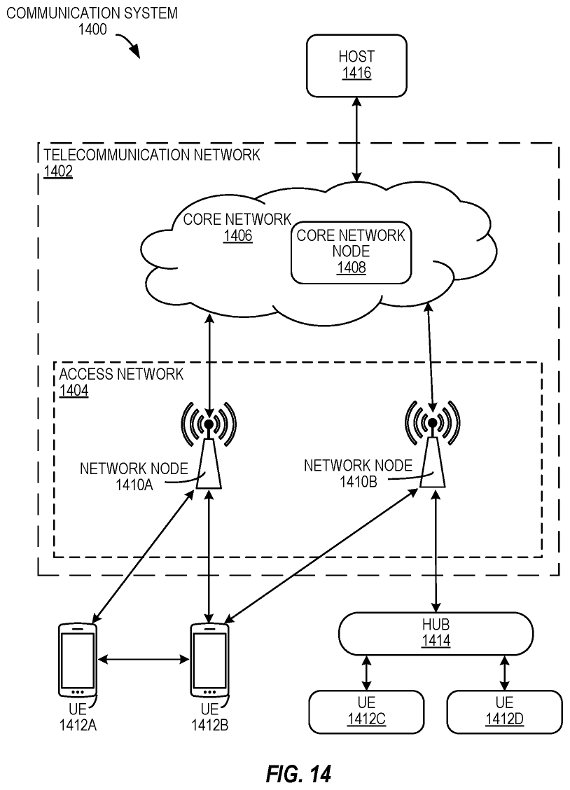

FIG. 14 shows an example of a communication system 1400 in accordance with some embodiments.

In the example, the communication system 1400 includes a telecommunication network 1402 that includes an access network 1404, such as a Radio Access Network (RAN), and a core network 1406, which includes one or more core network nodes 1408. The access network 1404 includes one or more access network nodes, such as network nodes 1410A and 1410B (one or more of which may be generally referred to as network nodes 1410), or any other similar Third Generation Partnership Project (3GPP) access node or non-3GPP Access Point (AP). The network nodes 1410 facilitate direct or indirect connection of User Equipment (UE), such as by connecting UEs 1412A, 1412B, 1412C, and 1412D (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system 1400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1402 is a cellular network that implements 3GPP standardized features. Accordingly, the telecommunication network 1402 may support network slicing to provide different logical networks to different devices that are connected to the telecommunication network 1402. For example, the telecommunication network 1402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1414 communicates with the access network 1404 to facilitate indirect communication between one or more UEs (e.g., UE 1412C and/or 1412D) and network nodes (e.g., network node 1410B). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a Virtual Reality (VR) headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410B. The hub 1414 may also allow for a different communication scheme and/or schedule between the hub 1414 and UEs (e.g., UE 1412C and/or 1412D), and between the hub 1414 and the core network 1406. In other examples, the hub 1414 is connected to the core network 1406 and/or one or more UEs via a wired connection. Moreover, the hub 1414 may be configured to connect to a Machine-to-Machine (M2M) service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410B. In other embodiments, the hub 1414 may be a non-dedicated hub—that is, a device which is capable of operating to route communications between the UEs and the network node 1410B, but which is additionally capable of operating as a communication start and/or end point for certain data channels.

FIG. 15 shows a UE 1500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1502 may include multiple Central Processing Units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging the power source 1508. Power circuitry may perform any formatting, converting, or other modification to the power from the power source 1508 to make the power suitable for the respective components of the UE 1500 to which power is supplied.

The memory 1510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1510 may allow the UE 1500 to access instructions, application programs, and the like stored on transitory or non-transitory memory media, to off-load data, or to upload data. An article of manufacture, such as one utilizing a communication system, may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., the antenna 1522) and may share circuit components, software, or firmware, or alternatively be implemented separately.

In the illustrated embodiment, communication functions of the communication interface 1512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1512, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

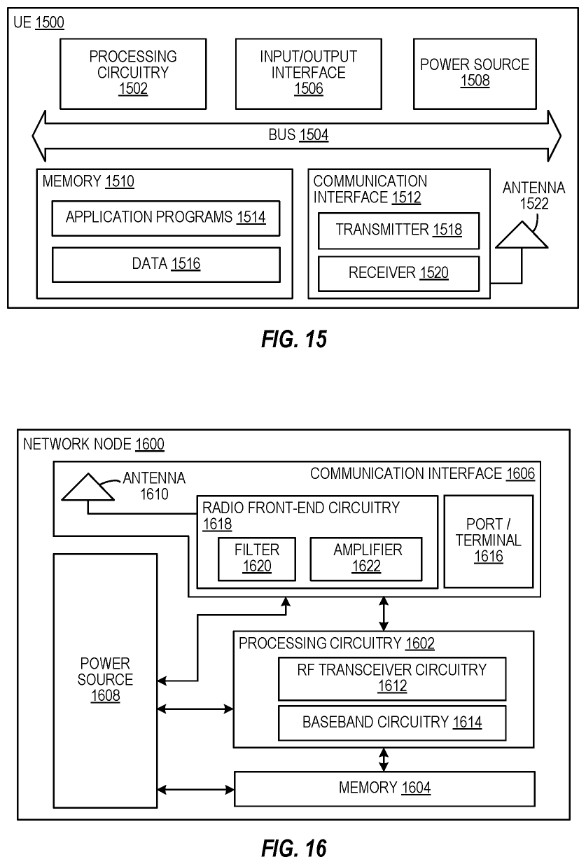

FIG. 16 shows a network node 1600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes processing circuitry 1602, memory 1604, a communication interface 1606, and a power source 1608. The network node 1600 may be composed of multiple physically separate components (e.g., a Node B component and an RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1600 may be configured to support multiple RATs. In such embodiments, some components may be duplicated (e.g., separate memory 1604 for different RATs) and some components may be reused (e.g., an antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1600.

The processing circuitry 1602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1600 components, such as the memory 1604, to provide network node 1600 functionality.

In some embodiments, the processing circuitry 1602 includes a System on a Chip (SOC). In some embodiments, the processing circuitry 1602 includes one or more of Radio Frequency (RF) transceiver circuitry 1612 and baseband processing circuitry 1614. In some embodiments, the RF transceiver circuitry 1612 and the baseband processing circuitry 1614 may be on separate chips (or sets of chips), boards, or units, such as radio units and digital units. In alternative embodiments, part or all of the RF transceiver circuitry 1612 and the baseband processing circuitry 1614 may be on the same chip or set of chips, boards, or units.

The memory 1604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and the memory 1604 are integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. The radio front-end circuitry 1618 comprises filters 1620 and amplifiers 1622. The radio front-end circuitry 1618 may be connected to the antenna 1610 and the processing circuitry 1602. The radio front-end circuitry 1618 may be configured to condition signals communicated between the antenna 1610 and the processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of the filters 1620 and/or the amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface 1606 may comprise different components and/or different combinations of components.

In certain alternative embodiments, the network node 1600 does not include separate radio front-end circuitry 1618; instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes the one or more ports or terminals 1616, the radio front-end circuitry 1618, and the RF transceiver circuitry 1612 as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, the communication interface 1606, and/or the processing circuitry 1602 may be configured to perform any receiving operations and/or certain obtaining operations described herein as being performed by the network node 1600. Any information, data, and/or signals may be received from a UE, another network node, and/or any other network equipment. Similarly, the antenna 1610, the communication interface 1606, and/or the processing circuitry 1602 may be configured to perform any transmitting operations described herein as being performed by the network node 1600. Any information, data, and/or signals may be transmitted to a UE, another network node, and/or any other network equipment.

The power source 1608 provides power to the various components of the network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid or an electricity outlet) via input circuitry or an interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

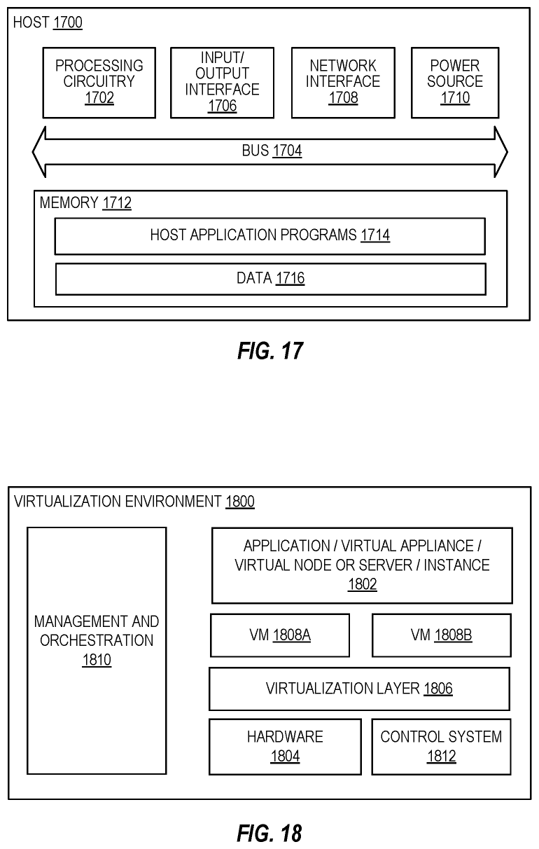

FIG. 17 is a block diagram of a host 1700, which may be an embodiment of the host 1416 of FIG. 14, in accordance with various aspects described herein. As used herein, the host 1700 may be or comprise various combinations of hardware and/or software including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and memory 1712. Other components may be included in other embodiments. Features of these components may be substantially similar to those described with respect to the devices of previous figures, such as FIGS. 15 and 16, such that the descriptions thereof are generally applicable to the corresponding components of the host 1700.

The memory 1712 may include one or more computer programs including one or more host application programs 1714 and data 1716, which may include user data, e.g. data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems).

The host application programs 1714 may also provide for user authentication and licensing checks and may periodically report health, routes, and content availability to a central node, such as a device in or on the edge of a core network. Accordingly, the host 1700 may select and/or indicate a different host for Over-The-Top (OTT) services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or VM Monitors (VMMs)), provide VMs 1808A and 1808B (one or more of which may be generally referred to as VMs 1808), and/or perform any of the functions, features, and/or benefits described in relation with some embodiments described herein. The virtualization layer 1806 may present a virtual operating platform that appears like networking hardware to the VMs 1808.

The VMs 1808 comprise virtual processing, virtual memory, virtual networking, or interface and virtual storage, and may be run by a corresponding virtualization layer 1806. Different embodiments of the instance of a virtual appliance 1802 may be implemented on one or more of the VMs 1808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1808 may be a software implementation of a physical machine that runs programs as if they were executing on a physical, non-virtualized machine. Each of the VMs 1808, and that part of the hardware 1804 that executes that VM, be it hardware dedicated to that VM and/or hardware shared by that VM with others of the VMs 1808, forms separate virtual network elements. Still in the context of NFV, a virtual network function is responsible for handling specific network functions that run in one or more VMs 1808 on top of the hardware 1804 and corresponds to the application 1802.

The hardware 1804 may be implemented in a standalone network node with generic or specific components. The hardware 1804 may implement some functions via virtualization. Alternatively, the hardware 1804 may be part of a larger cluster of hardware (e.g., such as in a data center or CPE) where many hardware nodes work together and are managed via management and orchestration 1810, which, among others, oversees lifecycle management of the applications 1802. In some embodiments, the hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1812 which may alternatively be used for communication between hardware nodes and radio units.

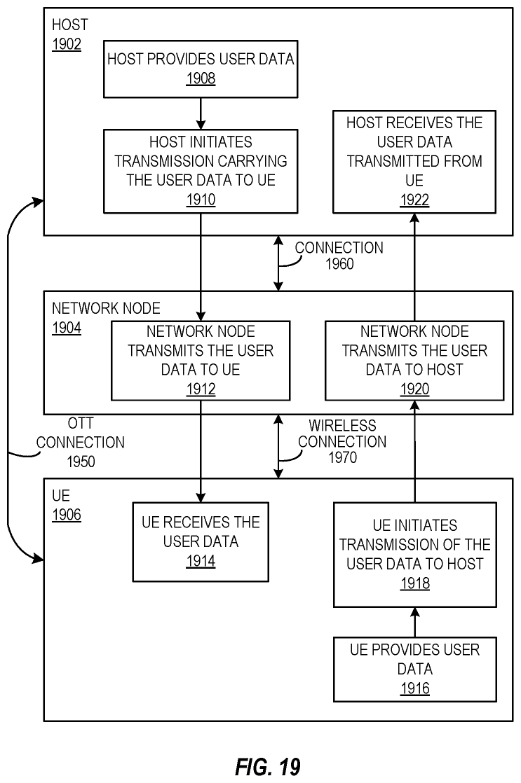

FIG. 19 shows a communication diagram of a host 1902 communicating via a network node 1904 with a UE 1906 over a partially wireless connection in accordance with some embodiments. Example implementations, in accordance with various embodiments, of the UE (such as the UE 1412A of FIG. 14 and/or the UE 1500 of FIG. 15), the network node (such as the network node 1410A of FIG. 14 and/or the network node 1600 of FIG. 16), and the host (such as the host 1416 of FIG. 14 and/or the host 1700 of FIG. 17) discussed in the preceding paragraphs will now be described with reference to FIG. 19.

Like the host 1700, embodiments of the host 1902 include hardware, such as a communication interface, processing circuitry, and memory. The host 1902 also includes software, which is stored in or is accessible by the host 1902 and executable by the processing circuitry. The software includes a host application that may be operable to provide a service to a remote user, such as the UE 1906 connecting via an OTT connection 1950 extending between the UE 1906 and the host 1902. In providing the service to the remote user, a host application may provide user data which is transmitted using the OTT connection 1950.

The network node 1904 includes hardware enabling it to communicate with the host 1902 and the UE 1906 via a connection 1960. The connection 1960 may be direct or pass through a core network (like the core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by the UE 1906 and executable by the UE's processing circuitry. The software includes a client application, such as a web browser or operator-specific “app” that may be operable to provide a service to a human or non-human user via the UE 1906 with the support of the host 1902. In the host 1902, an executing host application may communicate with the executing client application via the OTT connection 1950 terminating at the UE 1906 and the host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via the connection 1960 between the host 1902 and the network node 1904 and via a wireless connection 1970 between the network node 1904 and the UE 1906 to provide the connection between the host 1902 and the UE 1906. The connection 1960 and the wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904 in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR, or AR which it can broadcast, multicast, or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1950 between the host 1902 and the UE 1906 in response to variations in the measurement results. The measurement procedure and/or the network functionality for reconfiguring the OTT connection 1950 may be implemented in software and hardware of the host 1902 and/or the UE 1906. In some embodiments, sensors (not shown) may be deployed in or in association with other devices through which the OTT connection 1950 passes; the sensors may participate in the measurement procedure by supplying values of the monitored quantities exemplified above, or by supplying values of other physical quantities from which software may compute or estimate the monitored quantities. The reconfiguring of the OTT connection 1950 may include message format, retransmission settings, preferred routing, etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency, and the like by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment, UE, (1002), the method comprising any one or more of the following:
receiving (1004), from a network node (1000), information that configures the UE (1002) with a first SRS resource or resource set with a first SRS sequence and a first set of power control parameters and a second SRS resource or resource set with a second SRS sequence and a second set of power control parameters, wherein the first SRS resource or resource set and the second SRS resource or resource set are associated with a same set of SRS ports;
in response to an SRS trigger associated to both the first SRS resource or resource set and the second SRS resource or resource set:
   determining (1006), based on the first set of power control parameters, a first uplink power level for transmitting a first SRS using the first SRS resource or resource set with the first SRS sequence;
   transmitting (1008), at a first time instant, the first SRS using the first SRS resource or resource set with the first SRS sequence at the first uplink power level;
   determining (1010), based on the second set of power control parameters, a second uplink power level for transmitting a second SRS using the second SRS resource or resource set with the second SRS sequence; and
   transmitting (1012), at a second time instant that is different than the first time instant, the second SRS using the second SRS resource or resource set with the second SRS sequence at the second uplink power level.

Embodiment 2: The method of embodiment 1 wherein the first SRS resource or resource set is associated to a first TRP, and the second SRS resource or resource set is associated to a second TRP.

Embodiment 3: The method of embodiment 1 or 2 wherein the first time instant is a first OFDM symbol and the second time instant is a second OFDM symbol wherein the first OFDM symbol and the second OFDM symbol are not the same OFDM symbol.

Embodiment 4: The method of embodiment 1 or 2 wherein the first time instant is a first slot and the second time instant is a second slot wherein the first slot and the second slot are not the same slot.

Embodiment 5: The method of any of embodiments 1 to 4 wherein the first SRS resource or resource set and the second SRS resource or resource set are configured with usage ‘antenna switching’.

Embodiment 6: A method performed by a User Equipment, UE, (1102; 1202), the method comprising any one or more of the following:
receiving (1104; 1204), from a network node (1100; 1200), information that configures the UE (1102; 1202) with an SRS resource set with two or more pathloss reference signals;
determining (1108; 1210 or 1214) a first uplink power level for transmission of a first SRS for the SRS resource set based on at least one of the two or more pathloss reference signals configured for the SRS resource set; and
transmitting (1110; 1216) the first SRS using the first uplink power level.

Embodiment 7: The method of embodiment 6 wherein determining (1108) the first uplink power level for transmission of the first SRS for the SRS resource set based on the at least one of the two or more pathloss reference signals configured for the SRS resource set comprises determining (1108) the first uplink power level for transmission of the first SRS for the SRS resource set based on a first pathloss reference signal of the two or more pathloss reference signals configured for the SRS resource set.

Embodiment 8: The method of embodiment 7 further comprising: determining (1114) a second uplink power level for transmission of a second SRS for the SRS resource set based a second pathloss reference signal of the two or more pathloss reference signals configured for the SRS resource set; and transmitting (1116) the second SRS using the second uplink power level.

Embodiment 9: The method of embodiment 7 or 8 further comprising any one or more of the following: receiving (1106), from the network node (1100), a first indication (e.g., in a first DCI that triggers the SRS resource set) that indicates the first pathloss reference signal of the two or more pathloss reference signals configured of the SRS resource set; wherein determining (1108) the first uplink power level for transmission of the first SRS for the SRS resource set based the first pathloss reference signal is responsive to receiving (1108) the first indication (e.g., in the first DCI that triggers the SRS resource set) that indicates the first pathloss reference signal of the two or more pathloss reference signals configured of the SRS resource set.

Embodiment 10: The method of embodiment 7 or 8 further comprising: calculating (1206) two or more pathloss values based on the two or more pathloss reference signals configured for the SRS resource set, respectively; and selecting (1208) the first pathloss reference signal to be used for determining the first uplink power level based on the two or more pathloss values (e.g., select the one that is associated with the highest pathloss value).

Embodiment 11: The method of embodiment 6 further comprising: calculating (1206) two or more pathloss values based on the two or more pathloss reference signals configured for the SRS resource set, respectively; and calculating (1212) an average pathloss value based on two or more pathloss values; wherein determining (1214) the first uplink power level for transmission of the first SRS for the SRS resource set based on the at least one of the two or more pathloss reference signals configured for the SRS resource set comprises determining (1214) the first uplink power level for transmission of the first SRS for the SRS resource set based on the average pathloss value.

Embodiment 12: The method of any of embodiments 6 to 11 wherein the two or more pathloss reference signals are associated to two or more TRPs, respectively.

Embodiment 13: A method performed by a User Equipment, UE, (1302), the method comprising any one or more of the following:
receiving (1304), from a network node (1300), information that configures the UE (1302) with an SRS resource set with two or more pathloss reference signals;
transmitting (1306) one or more SRSs using the SRS resource set, wherein the one or more SRSs are transmitted such that either: (a) different uplink power levels based on the two or more pathloss reference signals are applied for different OFDM symbols of each SRS resource in the SRS resource set or (b) the UE (1302) sequentially sweeps through different uplink power levels that are based on the two or more pathloss reference signals for different SRS transmission occasions.

Embodiment 14: The method of any of the previous embodiments, further comprising: providing user data; and forwarding the user data to a host via the transmission to the network node.

### Group B Embodiments

Embodiment 15: A method performed by a network node (1000), the method comprising any one or more of the following:
transmitting (1004), to a User Equipment, UE, (1002), information that configures the UE (1002) with a first SRS resource or resource set with a first SRS sequence and a first set of power control parameters and a second SRS resource or resource set with a second SRS sequence and a second set of power control parameters, wherein:
   the first SRS resource or resource set and the second SRS resource or resource set are associated with a same set of SRS ports;
   the first SRS resource or resource set and the second SRS resource or resource set are associated with a same SRS trigger; and
   the first SRS resource or resource set and the second SRS resource or resource set are scheduled to be transmitted in different time instants.

Embodiment 16: The method of embodiment 15 wherein the first SRS resource or resource set is associated to a first TRP, and the second SRS resource or resource set is associated to a second TRP.

Embodiment 17: The method of embodiment 15 or 16 wherein the first time instant is a first OFDM symbol and the second time instant is a second OFDM symbol wherein the first OFDM symbol and the second OFDM symbol are not the same OFDM symbol.

Embodiment 18: The method of embodiment 15 or 16 wherein the first time instant is a first slot and the second time instant is a second slot wherein the first slot and the second slot are not the same slot.

Embodiment 19: The method of any of embodiments 15 to 18 wherein the first SRS resource or resource set and the second SRS resource or resource set are configured with usage ‘antenna switching’.

Embodiment 20: A method performed by network node (1100; 1200; 1300), the method comprising: transmitting (1104; 1204; 1304), to a UE (1102; 1202; 1302), information that configures the UE with an SRS resource set with two or more pathloss reference signals.

Embodiment 21: The method of any of the previous embodiments, further comprising: obtaining user data; and forwarding the user data to a host or a user equipment.

### Group C Embodiments

Embodiment 22: A user equipment comprising: processing circuitry configured to perform any of the steps of any of the Group A embodiments; and power supply circuitry configured to supply power to the processing circuitry.

Embodiment 23: A network node comprising: processing circuitry configured to perform any of the steps of any of the Group B embodiments; and power supply circuitry configured to supply power to the processing circuitry.

Embodiment 24: A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 25: A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

Embodiment 26: The host of the previous embodiment, wherein the cellular network further includes a network node configured to communicate with the UE to transmit the user data to the UE from the host.

Embodiment 27: The host of the previous 2 embodiments, wherein:
the processing circuitry of the host is configured to execute a host application, thereby providing the user data; and
the host application is configured to interact with a client application executing on the UE, the client application being associated with the host application.

Embodiment 28: A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

Embodiment 29: The method of the previous embodiment, further comprising: at the host, executing a host application associated with a client application executing on the UE to receive the user data from the UE.

Embodiment 30: The method of the previous embodiment, further comprising: at the host, transmitting input data to the client application executing on the UE, the input data being provided by executing the host application, wherein the user data is provided by the client application in response to the input data from the host application.

Embodiment 31: A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

Embodiment 32: The host of the previous embodiment, wherein the cellular network further includes a network node configured to communicate with the UE to transmit the user data from the UE to the host.

Embodiment 33: The host of the previous 2 embodiments, wherein: the processing circuitry of the host is configured to execute a host application, thereby providing the user data; and the host application is configured to interact with a client application executing on the UE, the client application being associated with the host application.

Embodiment 34: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 35: The method of the previous embodiment, further comprising: at the host, executing a host application associated with a client application executing on the UE to receive the user data from the UE.

Embodiment 36: The method of the previous embodiment, further comprising: at the host, transmitting input data to the client application executing on the UE, the input data being provided by executing the host application, wherein the user data is provided by the client application in response to the input data from the host application.

Embodiment 37: A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 38: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 39: A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

Embodiment 40: The method of the previous embodiment, further comprising, at the network node, transmitting the user data provided by the host for the UE.

Embodiment 41: The method of any of the previous 2 embodiments, wherein the user data is provided at the host by executing a host application that interacts with a client application executing on the UE, the client application being associated with the host application.

Embodiment 42: A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 43: The communication system of the previous embodiment, further comprising: the network node; and/or the user equipment.

Embodiment 44: A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 45: The host of the previous 2 embodiments, wherein:
the processing circuitry of the host is configured to execute a host application, thereby providing the user data; and
the host application is configured to interact with a client application executing on the UE, the client application being associated with the host application.

Embodiment 46: The host of the any of the previous 2 embodiments, wherein the initiating receipt of the user data comprises requesting the user data.

Embodiment 47: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 48: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment, UE, the method comprising any one or more of:
receiving, from a network node, information that configures the UE with a first Sounding Reference Signal, SRS, resource or resource set with a first SRS sequence and a first set of power control parameters and a second SRS resource or resource set with a second SRS sequence and a second set of power control parameters, wherein the first SRS resource or resource set and the second SRS resource or resource set are associated with a same set of antenna ports of the UE;
in response to a trigger or request to transmit SRS associated to one or both the first SRS resource or resource set and the second SRS resource or resource set:
determining, based on the first set of power control parameters, a first uplink power level for transmitting a first SRS using the first SRS resource or resource set with the first SRS sequence;
transmitting, at a first time instant(s), the first SRS using the first SRS resource or resource set with the first SRS sequence at the first uplink power level;
determining, based on the second set of power control parameters, a second uplink power level for transmitting a second SRS using the second SRS resource or resource set with the second SRS sequence; and
transmitting, at a second time instant(s) that is different than the first time instant(s), the second SRS using the second SRS resource or resource set with the second SRS sequence at the second uplink power level.

2. The method of claim 1 wherein the first time instant(s) is a first Orthogonal Frequency Division Multiplexing, OFDM, symbol(s) and the second time instant(s) is a second OFDM symbol(s) wherein the first OFDM symbol(s) and the second OFDM symbol(s) are not the same OFDM symbol(s).

3. The method of claim 1 wherein the first time instant(s) is in a first time slot and the second time instant(s) is in a second time slot wherein the first time slot and the second time slot are not a same time slot.

4. The method of claim 1 wherein the first SRS resource or resource set and the second SRS resource or resource set are configured for downlink channel state information, CSI, acquisition.

5. The method of claim 1 wherein the first SRS resource or resource set and the second SRS resource or resource set are configured with a parameter ‘usage’ set as ‘antenna switching’.

6. The method of claim 1 wherein the first set of power control parameters comprise a first pathloss reference Reference Signal, RS, and the second set of power control parameters comprise a second pathloss reference RS.

7. The method of claim 1 wherein the first SRS resource or resource set and the second SRS resource or resource set are one of periodic, semi-persistent, and aperiodic.

8. The method of claim 1 wherein the request is signaled in downlink control information, DCI.

9. (canceled)

10. A User Equipment, UE, comprising:
a communication interface comprising a transmitter and a receiver; and
processing circuitry associated with the communication interface, the processing circuitry configured to cause the UE to perform any one or more of:
receiving, from a network node, information that configures the UE with a first Sounding Reference Signal, SRS, resource or resource set with a first SRS sequence and a first set of power control parameters and a second SRS resource or resource set with a second SRS sequence and a second set of power control parameters, wherein the first SRS resource or resource set and the second SRS resource or resource set are associated with a same set of antenna ports of the UE;
in response to a request to transmit SRS associated to one of or both the first SRS resource or resource set and the second SRS resource or resource set:
determining, based on the first set of power control parameters, a first uplink power level for transmitting a first SRS using the first SRS resource or resource set with the first SRS sequence;
transmitting, at a first time instant, the first SRS using the first SRS resource or resource set with the first SRS sequence at the first uplink power level;
determining, based on the second set of power control parameters, a second uplink power level for transmitting a second SRS using the second SRS resource or resource set with the second SRS sequence; and
transmitting, at a second time instant that is different than the first time instant, the second SRS using the second SRS resource or resource set with the second SRS sequence at the second uplink power level.

11-24. (canceled)

25. A method performed by a network node, the method comprising:
transmitting, to a User Equipment, UE, information that configures the UE with a first Sounding Reference Signal, SRS, resource or resource set with a first SRS sequence and a first set of power control parameters and a second SRS resource or resource set with a second SRS sequence and a second set of power control parameters, wherein:
the first SRS resource or resource set and the second SRS resource or resource set are associated with a same set of antenna ports of the UE; and
the first SRS resource or resource set and the second SRS resource or resource set are scheduled to be transmitted in different time instants.

26. The method of claim 25 wherein the first time instant is a first Orthogonal Frequency Division Multiplexing, OFDM, symbol(s) and the second time instant(s) is a second OFDM symbol(s) wherein the first OFDM symbol(s) and the second OFDM symbol(s) are not the same OFDM symbol(s).

27. The method of claim 25 wherein the first time instant(s) is in a first time slot and the second time instant(s) is in a second time slot wherein the first time slot and the second time slot are not the same time slot.

28. The method of claim 25 wherein the first SRS resource or resource set and the second SRS resource or resource set are configured for downlink channel state information, CSI, acquisition with a higher layer parameter ‘usage” set as ‘antenna switching’.

29. (canceled)

30. A network node for a cellular communications system, the network node comprising processing circuitry configured to cause the network node to:
transmit, to a User Equipment, UE, information that configures the UE with a first Sounding Reference Signal, SRS, resource or resource set with a first SRS sequence and a first set of power control parameters and a second SRS resource or resource set with a second SRS sequence and a second set of power control parameters, wherein:
the first SRS resource or resource set and the second SRS resource or resource set are associated with a same set of antenna ports of the UE; and
the first SRS resource or resource set and the second SRS resource or resource set are scheduled to be transmitted in different time instants.

31-33. (canceled)
